(19) United States
(12) Patent Application Publication
(10) Pub. No.: US 2003/0039509 A1
(43) Pub. Date: Feb. 27, 2003

(54) Apparatus for laying pipeline

(76) Inventor: Garry McIvor, Okotoks (CA)

Correspondence Address: George A. Seaby, Seaby & Associates, 603-880 Wellington Street, Ottawa, ON, K1R 6K7, CA

(21) Appl. No.: 10/161,740

(22) Filed: Jun. 5, 2002

(30) Foreign Application Priority Data
Aug. 24, 2001 (CA) 2,356,463

(51) Int. Cl. F16L 1/028; B63B 35/04; B63B 35/03

(52) U.S. Cl. 404/2; 405/174; 405/154.1; 414/745.1; 405/170

(57) ABSTRACT

An apparatus for producing a pipeline includes a plurality of vehicles for straddling a ditch. Al of the vehicles are carried by wide, relatively soft tires for minimizing damage to the soil surface. A first vehicle receives, aligns and maintains sections of pipe in position over a trench while effecting a first weld. Additional welding of the joints between pipe sections is effected in successive vehicles, and the weld joint is inspected and then coated with plastic. Finally, the pipeline is deposited in the trench, and the latter is backfilled by the last vehicle in the train of vehicles.

### FIELD OF THE INVENTION

This invention relates to a pipe laying apparatus for use in the construction of a pipeline. More specifically, the invention relates to an apparatus for interconnecting and laying sections of pipe in a preformed trench.

### DISCUSSION OF THE PRIOR ART

The traditional method of building pipelines involves numerous pieces of heavy equipment requiring a large right-of-way of approximately thirty meters. Following the digging of a trench, sections of pipe are laid along the pipeline right of way beside the trench. The pipe sections are off-loaded and then exposed to the elements including snow, rain, mud and sand or dust storms. The next step is to weld the sections of pipe together and place them on pallets. Welding crews travel down the pipe to join the sections together. During welding, crews, side booms, tents and other machinery must all be moved simultaneously. In effect, one section of pipe is added at a time. The weld joints are inspected, and a procession of tractors equipped with booms are used to lay the pipe in the trench. Once the pipe has been laid, the trench is backfilled, and the pallets are removed.

Vehicle traffic along the right-of-way, especially by heavy vehicles and/or vehicles with narrow tires or metal tracks leads to significant soil compression or disturbance of the soil surface. In sensitive ecosystems, particularly in the Arctic, minimizing traffic is important in reducing damage to the environment. Peat moss is particularly prone to compression and compaction.

Examples of equipment for laying pipeline are described in Canadian Patents Nos. 963,276 issued to A. Wagley on Feb. 25, 1975; 1,053,919, issued to A. G. Bifani et al on May 8, 1979; 1,096,645, issued to M. Gibson on Mar. 3, 1981; 1,129,217, issued to O. M. Dahl on Aug. 10, 1982 and 2,066,768, issued to D. W. Jude on Oct. 19, 1999, and U.S. Pat. No. 2,780,376, issued to R. M. Sanders on Feb. 5, 1957; U.S. Pat. No. 3,900,146, issued to O. W. Fowler on Aug. 19, 1975; U.S. Pat. No. 4,051,687, issued to J. W. Ells on Oct. 4, 1977; U.S. Pat. No. 4,116,014, issued to C. R. Satterwhite on Sep. 26, 1978 and U.S. Pat. No. 4,232,982, issued to C. R. Satterwhite on Nov. 11, 1980. While some of the patents deal with various aspects of pipeline construction, it is readily apparent that a need still exists for a pipe laying system which provides solutions to the problems described above.

### GENERAL DESCRIPTION OF THE INVENTION

The object of the present invention is to satisfy such needs by providing a relatively simple apparatus, which is designed to have a minimal impact on the environment while reducing the possibility of human error in the laying of pipe.

Accordingly, the invention relates to an apparatus for producing a pipeline comprising:

(a) first vehicle means for receiving, aligning effecting a first weld between and maintaining sections of pipe in position over a trench in the ground while traveling over the trench to form a length of pipeline above the trench:

(b) second vehicle means for slidably receiving the sections of pipe and effecting at least one additional weld to said sections while following said first vehicle means over the trench;

(c) third vehicle means for slidably receiving the length of pipeline and inspecting welds and inspecting weld joints between the sections while following said first and second vehicle means over the trench;

(d) fourth vehicle means for covering said welds to complete the length of pipeline while following the first, second and third vehicle means over the trench; and

(e) fifth vehicle means for slidably receiving the length of pipeline, installing the length of pipeline in the trench and back-filling the trench while following the first, second, third and fourth vehicle means over the trench.

The invention also provides specific vehicles for effecting the above listed operations, not the least of which is a pipe handling vehicle for storing, loading and aligning sections of pipe at the front end of the apparatus.

### BRIEF DESCRIPTION OF THE DRAWINGS

The invention is described below in greater detail with reference to the accompanying drawings, which illustrate a preferred embodiment of the invention, and wherein:

FIG. 1 is a schematic top view of a pipe laying apparatus in accordance with the invention;

FIG. 2 is a schematic side view of a pipe handling vehicle used in the apparatus of FIG. 1;

FIG. 3 is a top view of the vehicle of FIG. 2;

FIG. 4 is a side view of the vehicle of FIGS. 2 and 3 on a large scale;

FIG. 5 is a top view of the vehicle of FIGS. 2 and 3 on a large scale;

FIG. 6 is a front view of wheel and steering assemblies used in the vehicle of FIGS. 2 to 5;

FIG. 7 is a top view of the wheel and steering assemblies of FIG. 6;

FIGS. 8 and 9 are front views of one side of a frame used in the vehicle of FIGS. 2 to 5 in upper and lower positions;

FIG. 10 is a partly sectioned view of one end of a wheel carriage used in the wheel assembly of FIGS. 6 and 7;

FIG. 11 is a front view of a track and carriage used in the wheel and steering assemblies;

FIG. 12 is a cross section taken generally along line 12-12 of FIG. 11;

FIG. 13 is a front view of the carriage of FIGS. 11 and 12;

FIGS. 14 and 15 are cross sections taken generally along lines 14-14 and 15-15, respectively of FIG. 13;

FIG. 16 is a top view of the steering assembly of FIGS. 6 and 7;

FIG. 17 is a front view of the steering assembly of FIG. 16;

FIG. 18 is an end view of the steering assembly of FIG. 16

FIG. 19 is a front view of cradles for receiving pipe sections;

FIG. 20 is a front view of a stop used on the cradles of FIG. 19;

FIG. 21 is a top view of the cradles of FIG. 19 and pivot arms;

FIG. 22 is a front view of the cradles of FIG. 19 and an elevator for lowering pipe sections onto the vehicle

FIG. 23 is a top view of a cradle used in the elevator of FIG. 22;

FIG. 24 is a front view of the cradle of FIG. 23;

FIG. 25 is front view of pipe feed rollers;

FIG. 26 is a front view of a pipe manipulating device;

FIG. 27 is a top view of the pipe manipulator of FIG. 26 with parts omitted;

FIG. 28 is a front view of a pipe rotator used in the vehicle of FIGS. 2 to 5;

FIG. 29 is a top view of the pipe rotator of FIG. 28;

FIG. 30 is a front view of a pipe feed assembly used in the vehicle of FIGS. 2 to 5;

FIG. 31 is a partly sectioned front view of an arm used in the assembly of FIG. 30; and

FIG. 31 is a rear view of the vehicle of FIGS. 2 to 5.

For the sake of simplicity, parts have been omitted from many of the drawings, and the figures are not on the same scale. However, it is believed that the invention will be fully understood from the following.

### DESCRIPTION OF THE PREFERRED EMBODIMENT

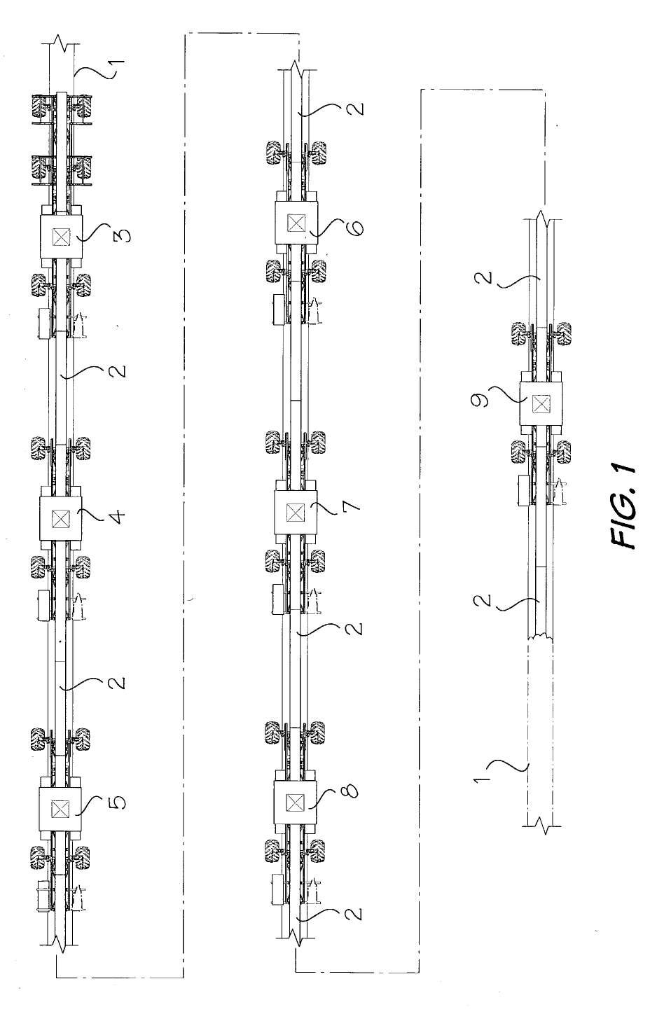

With reference to FIG. 1, the basic elements of a pipe laying apparatus in accordance with the present invention include a plurality of vehicles designed to straddle and travel along an existing trench 1 for joining and laying sections 2 of pipe therein. Preferably the trench digging machine (not shown), which does not form part of this invention, has wide soft tires for minimizing damage to the surface of the ground. A first vehicle 3 receives the pipe sections 2 from a truck (not shown), stores the pipe, loads the pipe sections one at time onto a conveyor and aligns each section 2 with already aligned and or joined pipe sections. The first vehicle 3 also performs the root pass on a butt weld between successive pipe sections. As the vehicles advance, the pipe sections 2 pass through a second vehicle 4 where a fill weld is performed, and then a third vehicle 5 where the cap weld is applied to the butt joint. Successive vehicles 6 to 9 for receiving the pipe sections 2 contain mechanized inspection equipment for performing X-ray or ultrasonic examination of the welds, application of a plastic shrink wrap to the joint area between sections, and laying of the pipe sections into the ground and finally back filling of the trench.

It will be appreciated that the above described combination of vehicles straddling the trench eliminates the need for a wide right of way. Instead of thirty meters, an approximately twelve meter right of way should suffice.

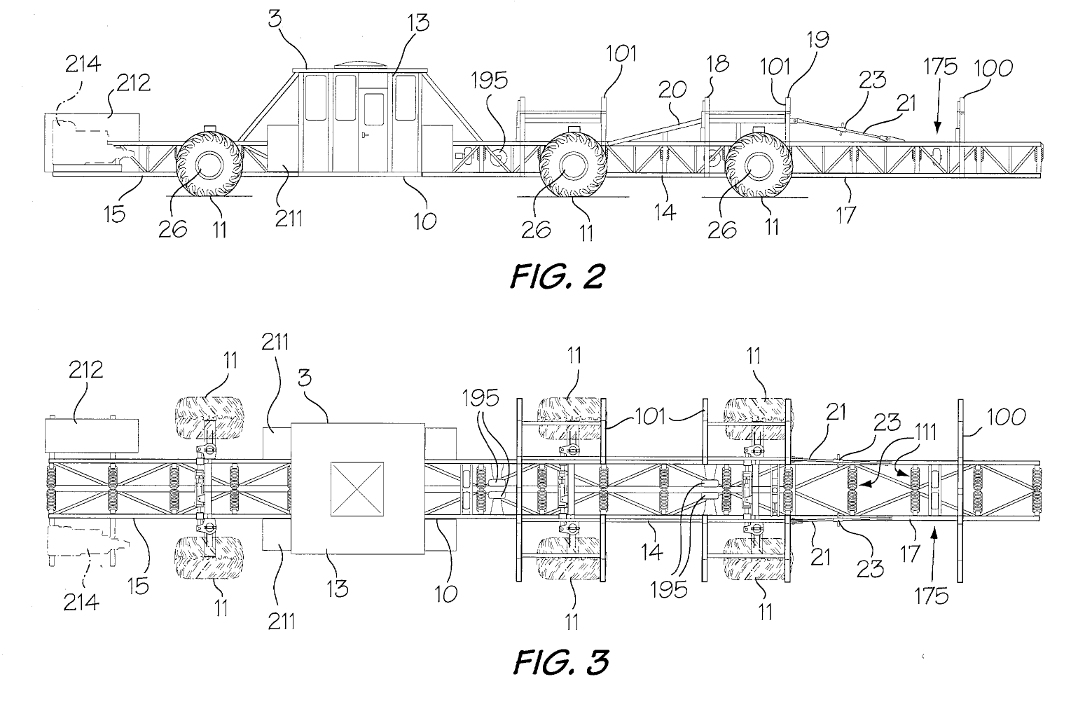

Referring to FIGS. 2 and 3, the vehicle 3 for handling the pipe sections 2 includes a skeletal frame 10 supported for movement along the ground by large, wide tires 11. The wide tires 11 minimize damage to the terrain over which the vehicle travels. For example, the soil compression and compaction mentioned above is minimized. Moreover, wide tires reduce the likelihood of wheel spin which adversely affects the integrity of soil surfaces. A cab 13 housing controls (not shown) separates the frame 10 into front and rear sections 14 and 15, respectively. The cab 13 also contains welding equipment (not shown) for traveling around the pipe sections 2 where they abut and applying a first or root weld thereto. An extension 17 is cantilevered from the leading end of the front frame section 15 for supporting one end of longer pipe sections 2. For short pipe sections 2, the extension 17 can be omitted from the vehicle 3. The extension 17 is supported by posts 18 and 19 on the frame 10 and on the extension 17, diagonal braces 20 on the front frame section 15 and diagonal bars 21 pivotally connected to the posts 19 and the extension 17. Turnbuckles 23 in the bars 21 facilitate leveling of the extension 17.

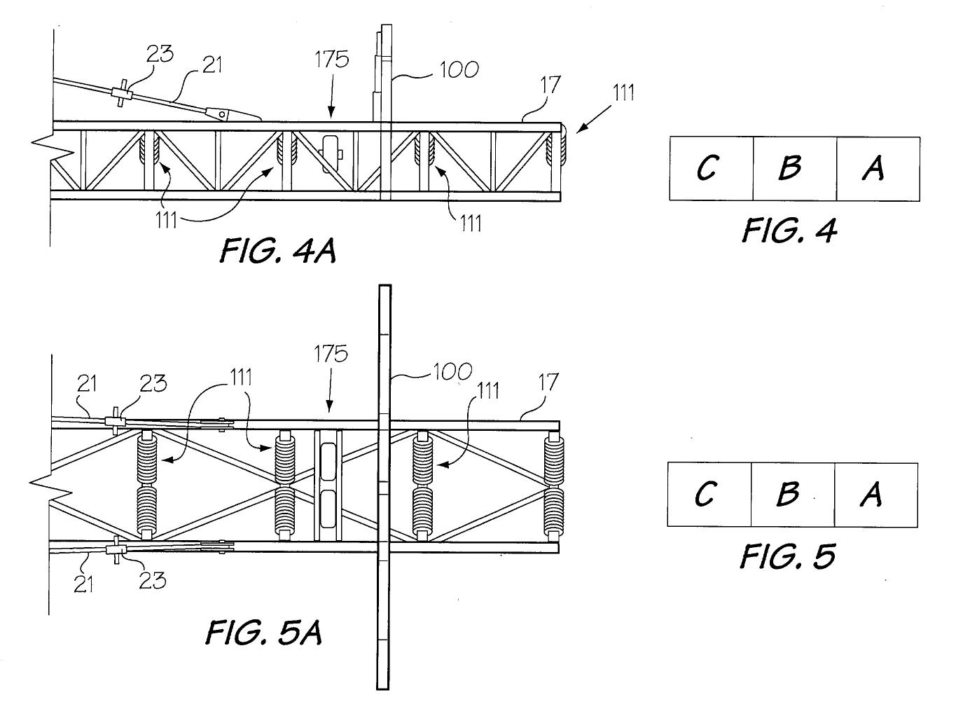

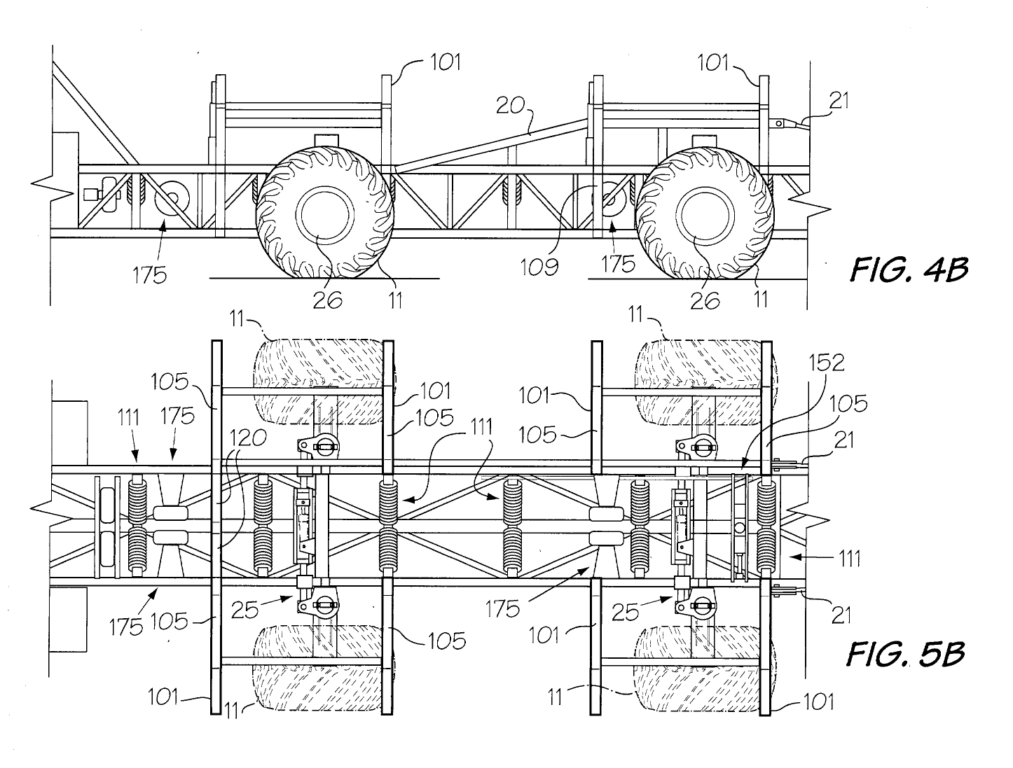

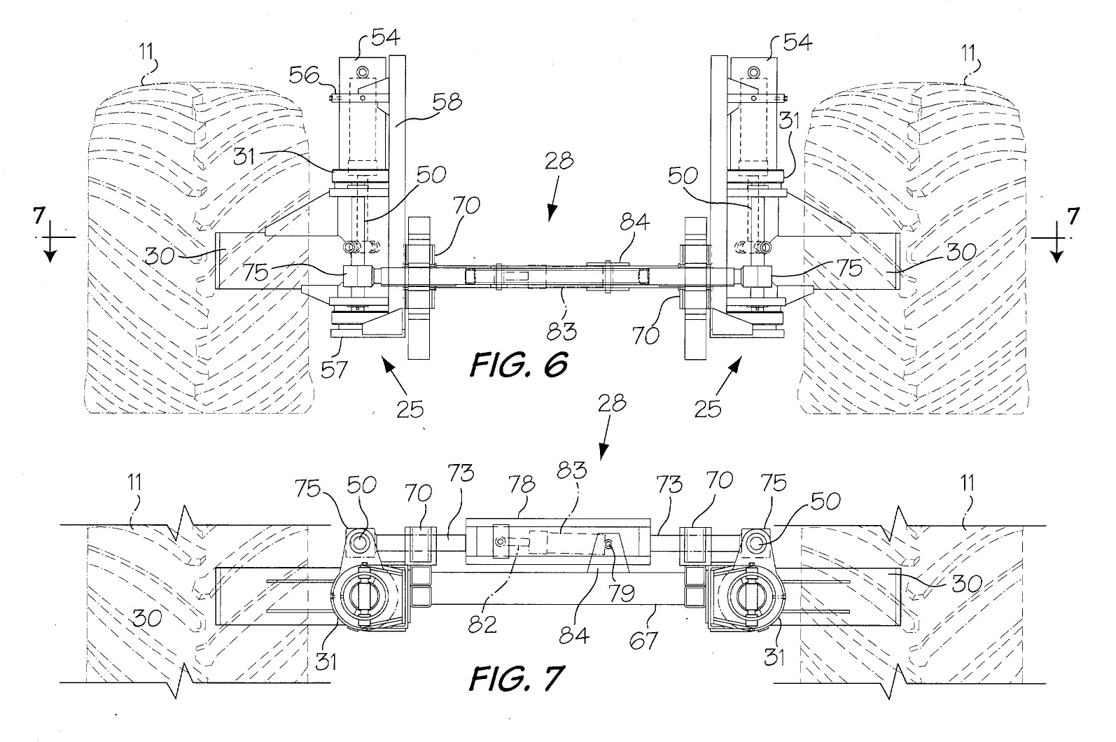

As mentioned above, the frame 10 is supported by tires 11. The tires 11 are part of wheel assemblies indicated generally at 25, each of which includes a pair of wheels 26 (FIGS. 2 and 4) supporting opposite sides of the frame 10. The wheels 26 are driven individually, but are interconnected by a steering assembly 28 (FIGS. 6, 7 and 16 to 18) for turning in unison.

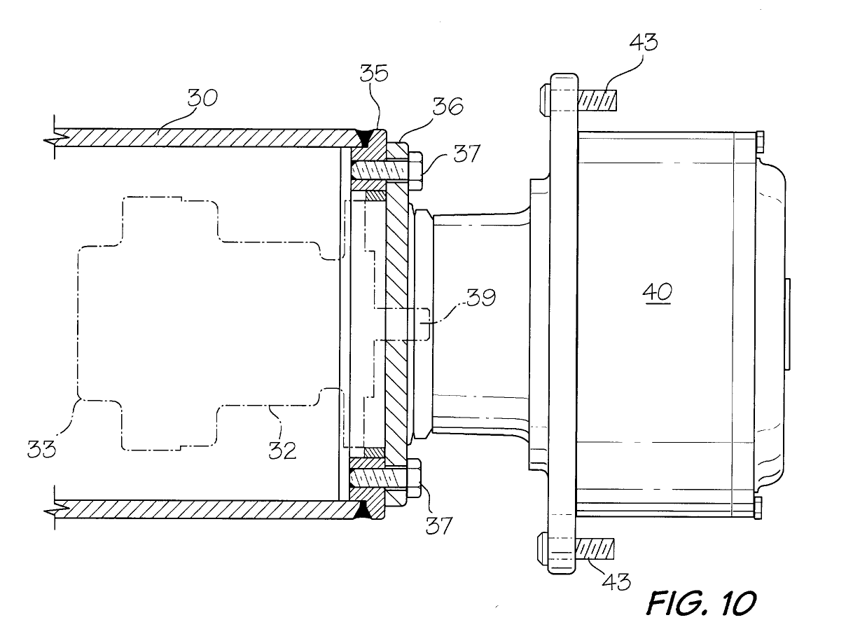

Referring to FIGS. 6 to 9, each wheel assembly 25 includes a pair of wheels 26 mounted on the free ends of tubular arms 30 defining the stem of generally T-shaped carriages 31. A hydraulic motor 32 (FIG. 10) and a brake 33 are mounted in the outer free end of each arm 30, which is closed by a ring 35, and a plate 36 connected to the ring 35 by bolts 37. The shaft 39 of the motor 32 is connected to a bearing assembly 40, which is connected to the hub 41 of the wheel 26 by bolts 43. The arm 30 is welded to a tubular vertical arm 44 of the carriage 31, and reinforcing gussets 45 extend between the arms 30 and 44 for strengthening the carriage.

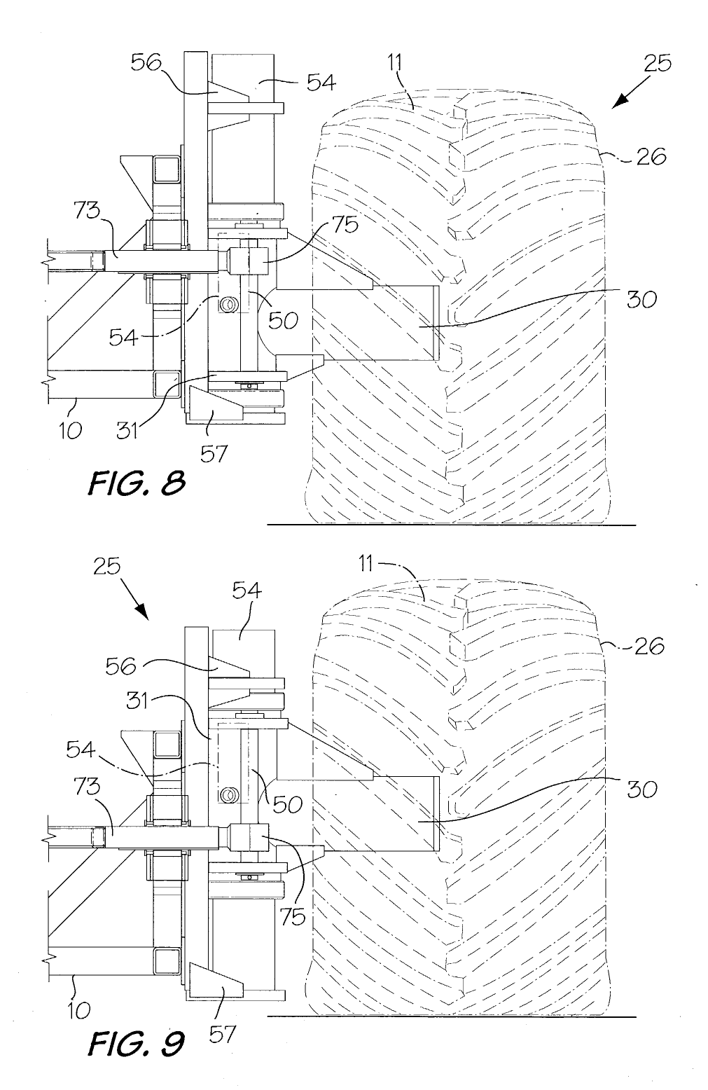

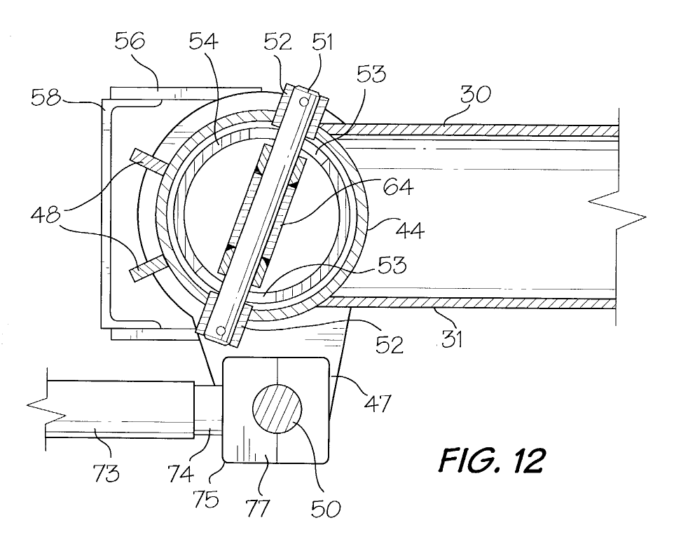

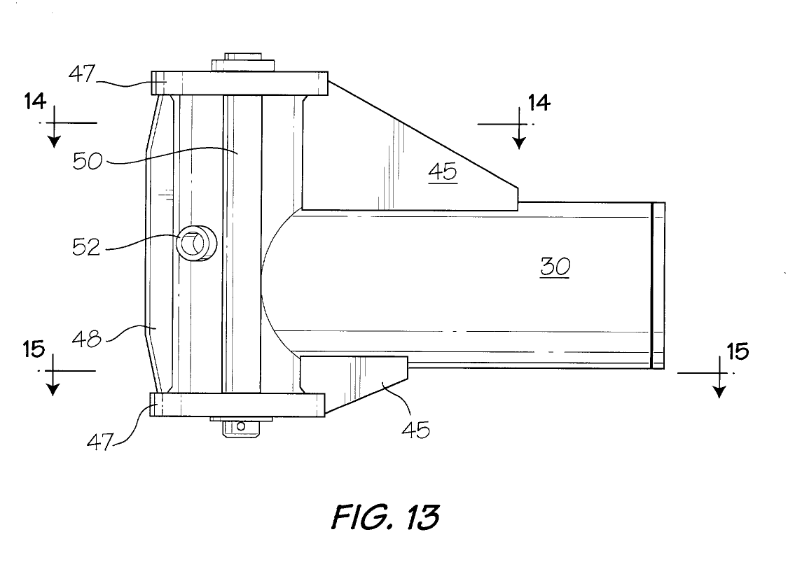

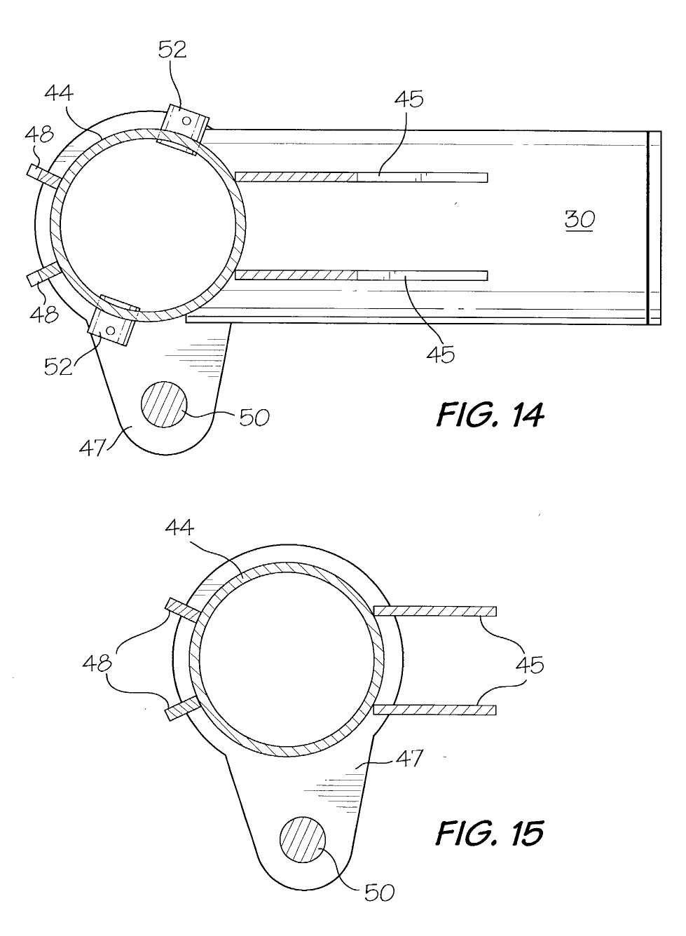

The gussets 45 are welded to the arms 30 and 44, and to brackets 47 in the form of flanges on the top and bottom ends of the arm 44. Additional gussets 48 extend between the brackets 47 for reinforcing the carriage 31. A steering shaft 50 also extends between the brackets 47. A pin 51 (FIG. 12) extending between diametrically opposed bushings 52 in the arm 44 of the carriage 31 is rotatable and vertically movable in diametrically opposed, rectangular openings 53 (FIGS. 8, 9 and 12) in a tubular track 54. The track 54 is removably mounted in brackets 56 and 57 on a post 58 having a C-shaped cross section which in turn is welded to a side of the frame 10. Gussets 59 reinforce the connection between the brackets 56 and 57 and the post 58.

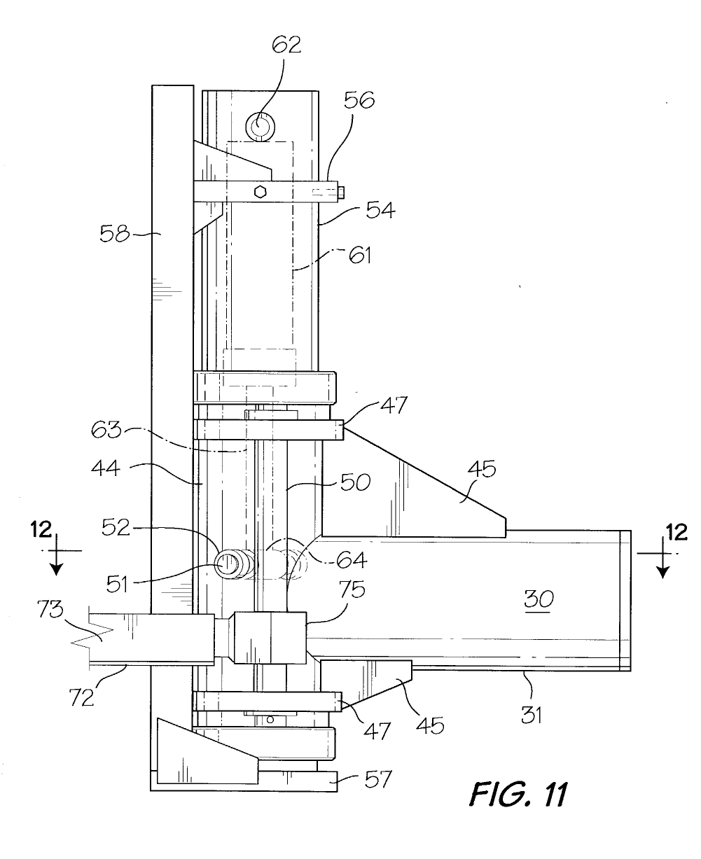

A hydraulic cylinder 61 (FIG. 11) is pivotally mounted on a pin 62 near the top end of the track 54. The bottom end of a piston rod 63 extending downwardly form the cylinder 61 is connected to a sleeve 64 (FIGS. 11 and 12) on the pin 51 for moving the carriage 31 vertically on the track 54. As shown in FIGS. 8 and 9, such movement of the carriage 31 results in corresponding movement of the frame 10 to change the clearance between the bottom of the frame 10 and the ground. The pin 51 extending through the openings 53 in the track 54 limits vertical movement of the carriage 31 on the track 54.

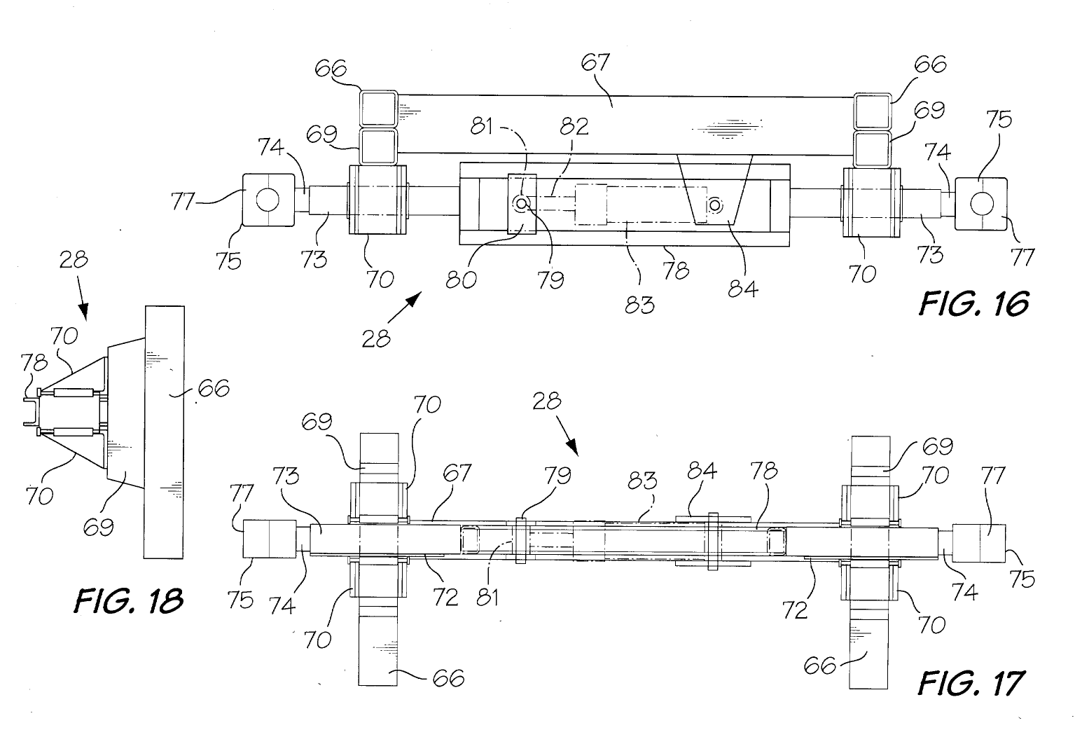

Steering of the apparatus is effected by the steering assembly indicated generally at 28 in FIGS. 8 and 8. Referring to FIGS. 16 to 18, the steering assembly 28 includes a frame defined by posts 66 on the sides of the frame 10, and a crossbar 67 extending between the posts 66. A tubular spacer 69, with beveled top and bottom ends, is connected to the post 66 and carries a pair of brackets 70. Plastic plates 72 on the brackets 70 slidably support a rod 73, the outer end of which receives a rod 74, which forms part of a tie assembly 75. The tie assembly 75 includes a two-part block 77 containing a bushing (not shown) for slidably and rotatably receiving the steering shaft 50 on the carriage 31, whereby longitudinal movement of the rod 73 results in turning of the carriage 31 and consequently the wheel attached thereto. The inner ends of the rods 73 are connected to opposite ends of a rectangular frame 78. A pin 79 extending through crossbars 80 on the frame 78 connects the latter to a sleeve 81 on the outer free end of a piston rod 81. The piston rod 81 extends out of a cylinder 83, the closed end of which is pivotally connected to a bracket defined by plates 84 extending outwardly from the crossbar 67. Extension or retraction of the piston rod 81 results in rotation of the carriages 31 at each end of the steering assembly, and consequently turning of the wheels.

The pipe sections 2 are unloaded from a truck (not shown) onto cradles 100 and 101 on the front frame section 14. The cradles 100 are defined by inclined arms 102 on the top of the extension 17 each of which receives pipe sections 2, i.e. the pipe sections are loaded onto both side of the front fame section 14 and the extension 17. Each cradle 101 includes a pair of inclined arms 105, inner posts 106 connected to the frame 10, and stop posts 107 at the outer end of each arm 105. Diagonal braces 109 extend between the bottom of the post 106 and the arms 105.

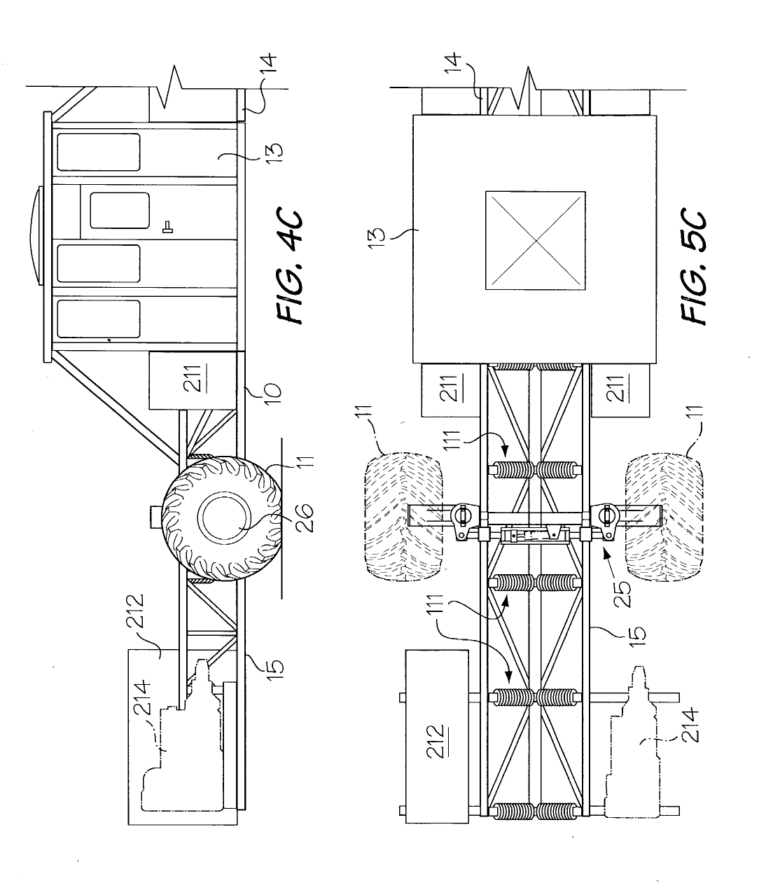

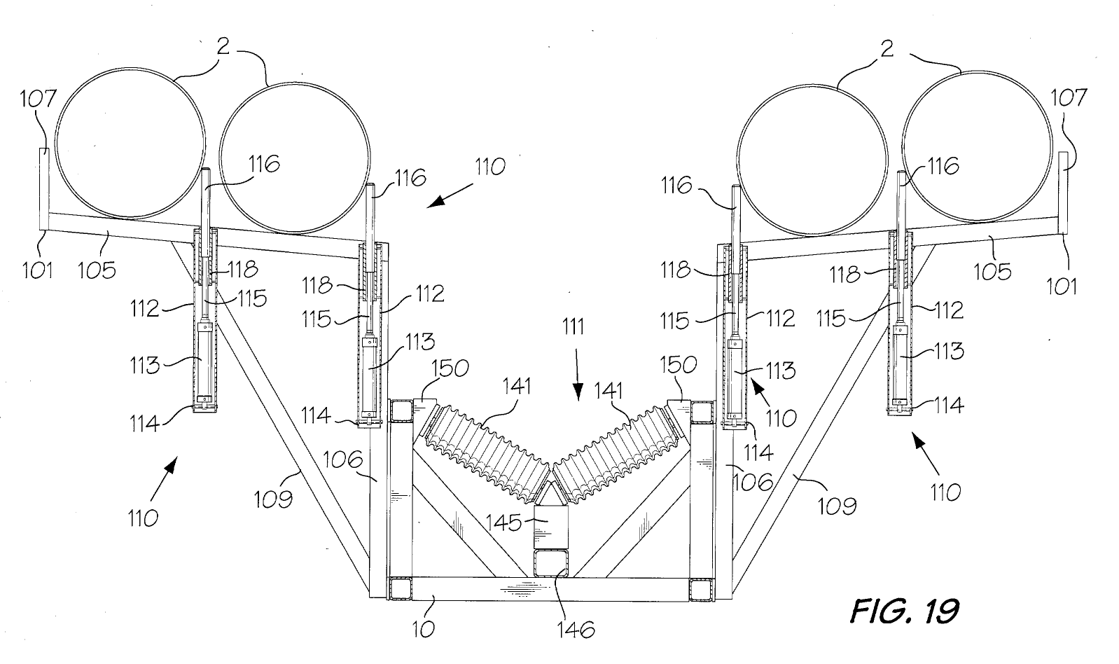

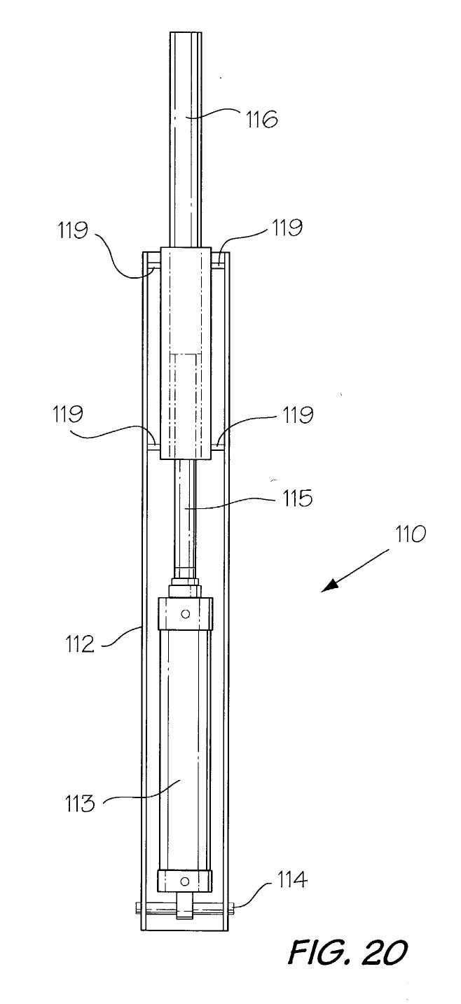

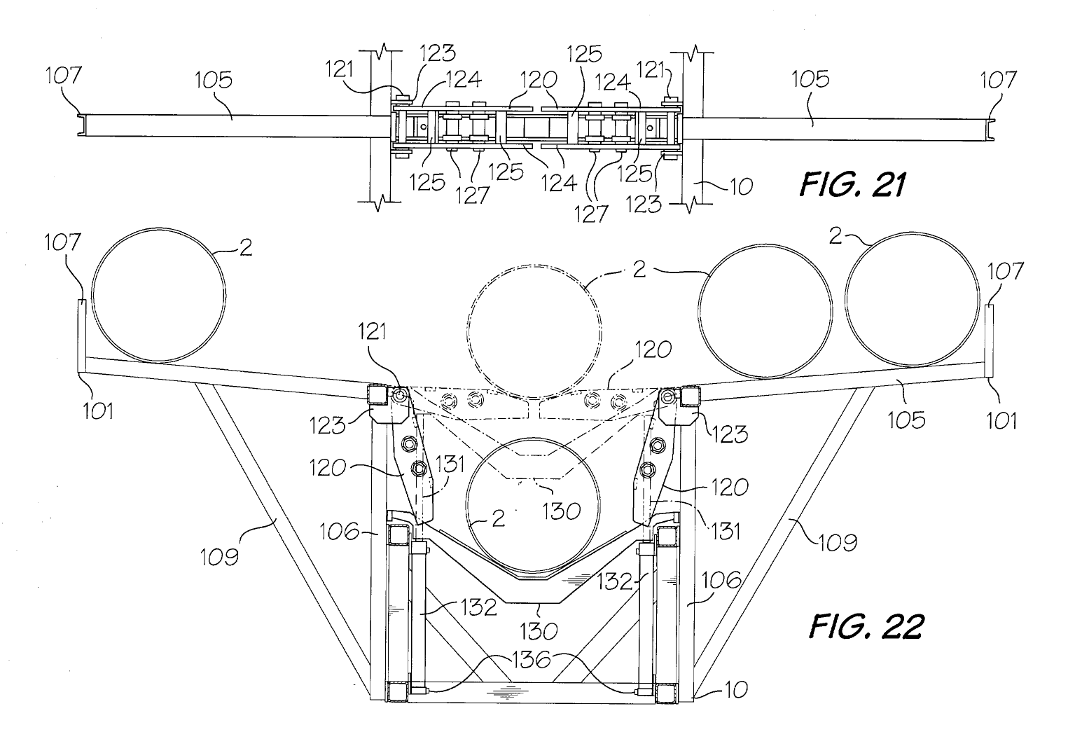

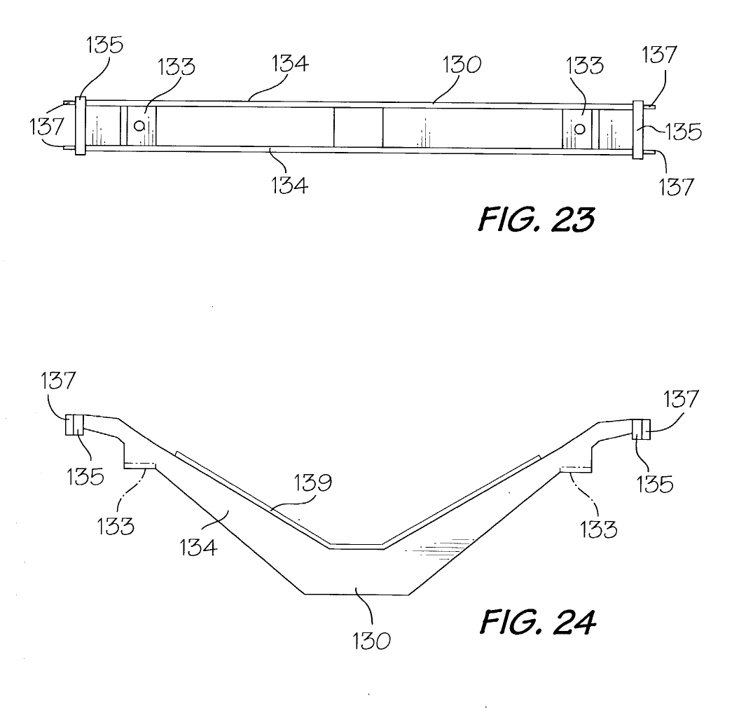

Retractable stops indicated generally at 110 retain the pipe sections 2 on the cradles 101 and ensure feed of the pipe sections one at a time to a conveyor defined by roller assemblies 111 (FIG. 19). As best shown in FIG. 20, each stop 110 includes an elongated casing 112 of C-shaped cross section. The bottom end of a hydraulic cylinder 113 is pivotally mounted on a pin 114 extending between the sides of the bracket 112. A piston rod 115 extending out of the top of the cylinder 113 carries a cylindrical bar 116, which is slidable in a sleeve 118 mounted in the top end of the bracket 112 using plates 119. When the bars 116 are extended (FIG. 19) they prevent downward and inward movement of the pipe sections 2 on the cradles 101. When loading a pipe section 2 onto the roller assembles 111 one set of innermost stop bars 116, i.e the innermost stop bars 116 on one side of the front frame 10 are retracted and a pipe section 2 rolls onto opposed pivot arms 120 (FIG. 21). Once the pipe section has rolled onto the arms 120, the innermost stop bars 116 are again extended, and the second or outer stop bars are retracted to permit a fresh pipe section to roll into position adjacent to the pivot arms 120. While only one set of pivot arms 120 are shown in FIG. 5, it will be appreciated that additional pivot arms will be present on the front frame section 14 and/or the extension 17 for receiving each pipe section 2 at spaced apart locations.

With reference to FIGS. 21 and 22, the pivot arms 120 are pivotally connected by pins 121 to brackets 123 on the sides of the frame 10. Each pivot arm includes a pair of sides 124 interconnected by crossbars 125. A pair of rollers 127 extend between the sides 124 on either side of the middle thereof. The pivot arms 120 are retained in the elevated or raised positions shown in phantom outline in FIG. 22 by a cradle 130, which defines the top of an elevator for lowering the pipe sections 2 onto the conveyor defined by the roller assemblies 111. Piston rods 131 extending out of hydraulic cylinders 132 are connected to crossbars 133 extending between the sides 134 of the cradle near the ends 135 thereof. The cylinders 132 are pivotally connected to the bottom of the frame 10 by pins 136. The cradle 130 is guided for vertical movement on the cradle posts 106 by fingers 137 on the ends 135 of the cradle. The cradle 130 moves vertically between a raised position shown in phantom outline in FIG. 22 and a lower position shown in solid outline in FIG. 22.

As the cradle 130 is lowered, the pivot arms 120 follow the cradle until the space between the free ends of the arms 120 is sufficiently large that the pipe section 2 drops onto and is supported by a rubber pad 139 (FIG. 24) only. The cradle 130 continues to move downwardly until the pipe section 2 rests on the roller assemblies 111.

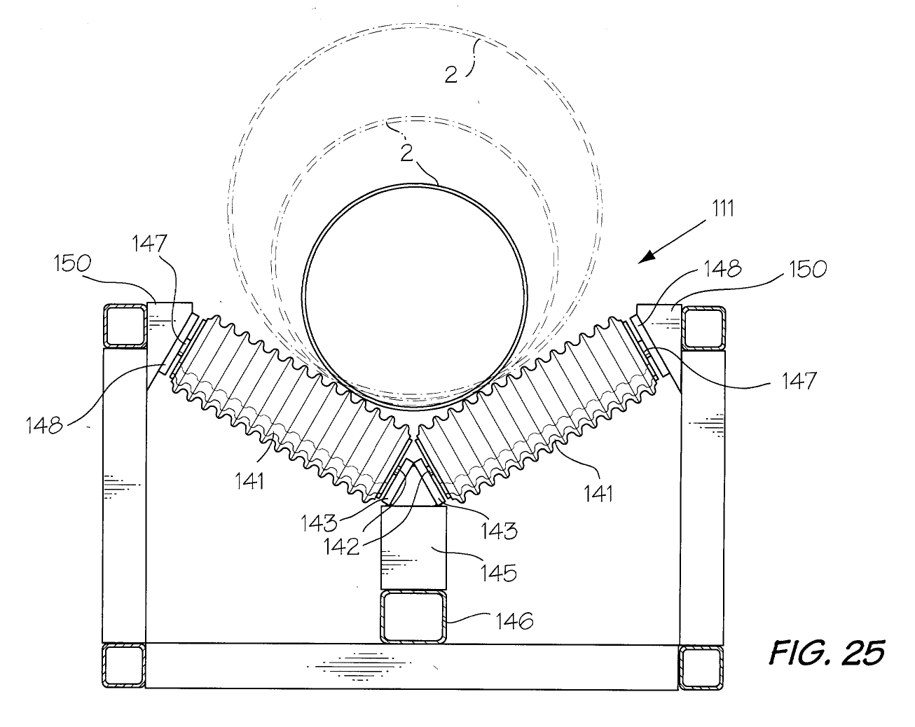

As mentioned above, the vehicle 3 is designed for handling pipe sections 2, i.e. loading, manipulating and feeding pipe sections rearwardly to already assembled pipeline. Actually, once the pipe sections 2 abut with existing pipeline and are welded in the cab 13, the vehicle 3 moves forwardly while the pipe sections 2 remain stationary. The pipe sections 2 are received and carried by a plurality of the V-shaped roller assemblies indicated generally at 111 (FIGS. 2 and 3) between the sides of the frame 10, and the extension 17. Each roller assembly 111 (FIGS. 19 and 25) includes a pair of inclined, corrugated rollers 141. Shafts 142 extending out of the bottom ends of the rollers 141 are mounted in plates 143 on the top ends of posts 145, which extend upwardly from a longitudinally extending supporting bar 146 on the bottom center of the frame 10 and extension 17. Shafts 147 on the top ends of the rollers 141 are mounted in plates 148 on generally triangular frames 150 at the top of each side of the frame 10 and extension 17. The V-shaped roller assembly 111 is adapted to support and feed pipe sections 2 having a large variety of diameters.

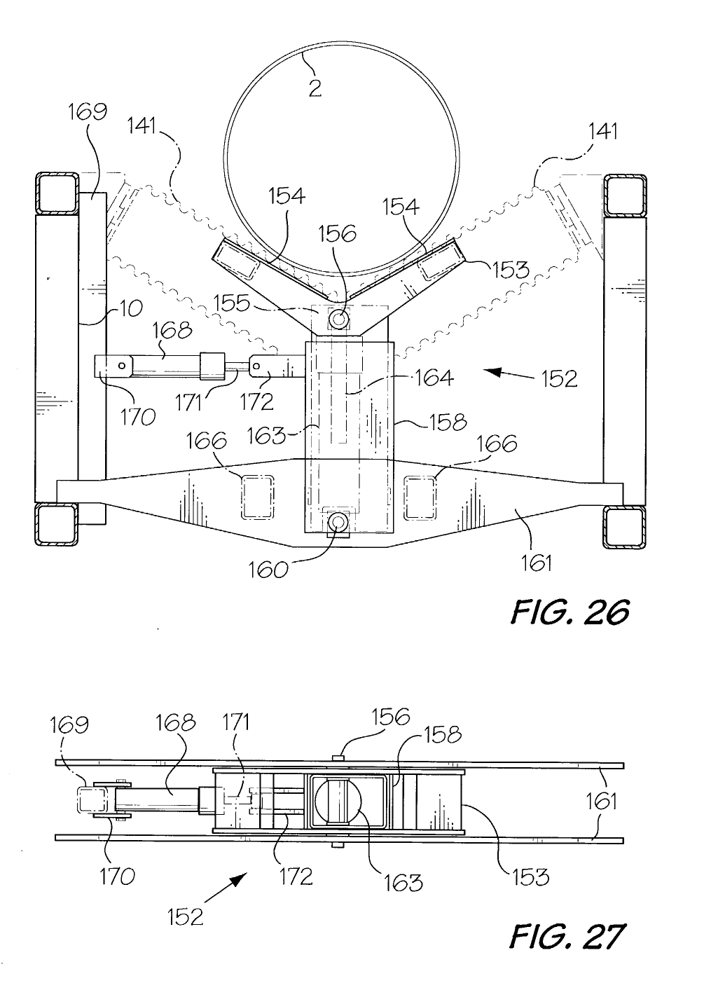

Once in position on the roller assemblies 111, the orientation of the pipe section 2 is adjusted. The pipe section 2 is moved vertically and laterally of the frame by adjustment mechanisms indicated generally at 152 (FIGS. 5, 26 and 27). Each adjustment mechanism 152 includes a shallow V-shaped cradle 153 with pads 154 on the top thereof for receiving a pipe section 2. The cradle 153 is connected to the top end of a rectangular cross section tube 155 by a pin 156. The tube 155 is slidably mounted in a sleeve 158. The bottom end of the sleeve 158 is pivotally connected by a pin 160 to a pair of crossbars 161 extending between the sides of the frame 10 at the bottom of the adjustment mechanism 152. The tube 155 and consequently the cradle 153 are moved vertically by a hydraulic cylinder 163, the bottom end of which is connected to the sleeve 158 by the pin 160. A piston rod 164 extends upwardly from the cylinder 163 and is connected to the top end of the tube 155 by the pin 156. Rotation of the sleeve 158 around the axis of the pin 160 is limited by bars 166 extending between the crossbars 161. The sleeve 158 and consequently the cradle 153 and any pipe section 2 thereon is moved laterally of the frame 10 by a hydraulic cylinder 168, the closed end of which is pivotally connected to a post 169 on one side of the frame 10 by a bracket 170. A piston rod 171 extending out of the inner end of the cylinder 168 is pivotally connected to the sleeve 158 by a clevis 172.

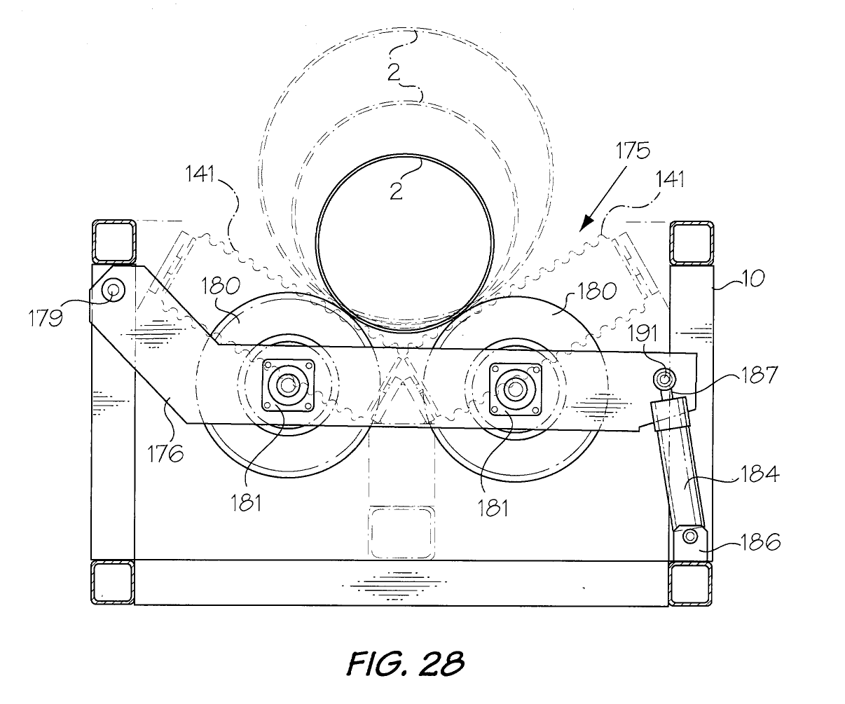

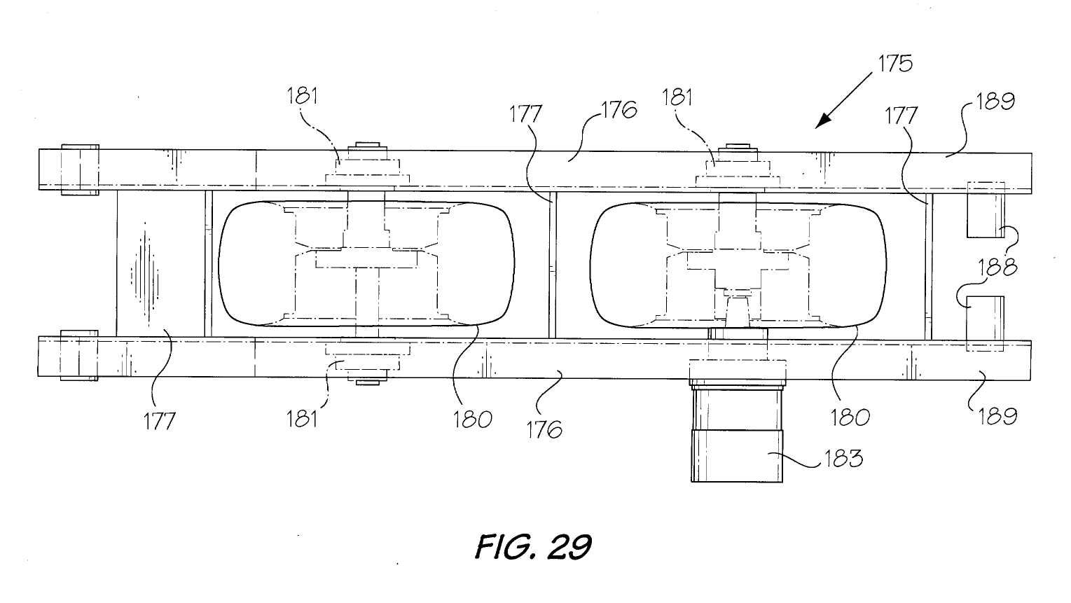

Many pipeline producers want the longitudinal seam (not shown) on each pipe section 2 on the top center of the pipeline. For such purpose a pipe rotator indicated generally at 175 is provided on the frame 10. The rotator 175 includes a pair of parallel arms 176 and crossbars 177 defining a frame, one end of which is pivotally connected to one side of the frame 10 by a pin 179 (FIG. 28). A pair of wheels 180 are mounted in bearings 181 in the arms 172. One of the wheels 180 is rotated by a reversible motor 183 (FIG. 29) mounted on one of the arms 176. The wheels 180 are brought into contact with a pipe section 24 by a hydraulic cylinder 184, the closed bottom end of which is pivotally connected to the other side of the frame 10 by a clevis 186. A piston rod 187 extending out of the top of the cylinder 184 is pivotally connected to bushings 188 on the free end 189 of the arms 176 by a pin 191. When the cylinder 184 is actuated to raise the wheels 180 into contact with a pipe section 2, the motor 183 is started to rotate the pipe section 2 until the longitudinal seam thereon is on top and aligned with the seams on already interconnected pipe sections.

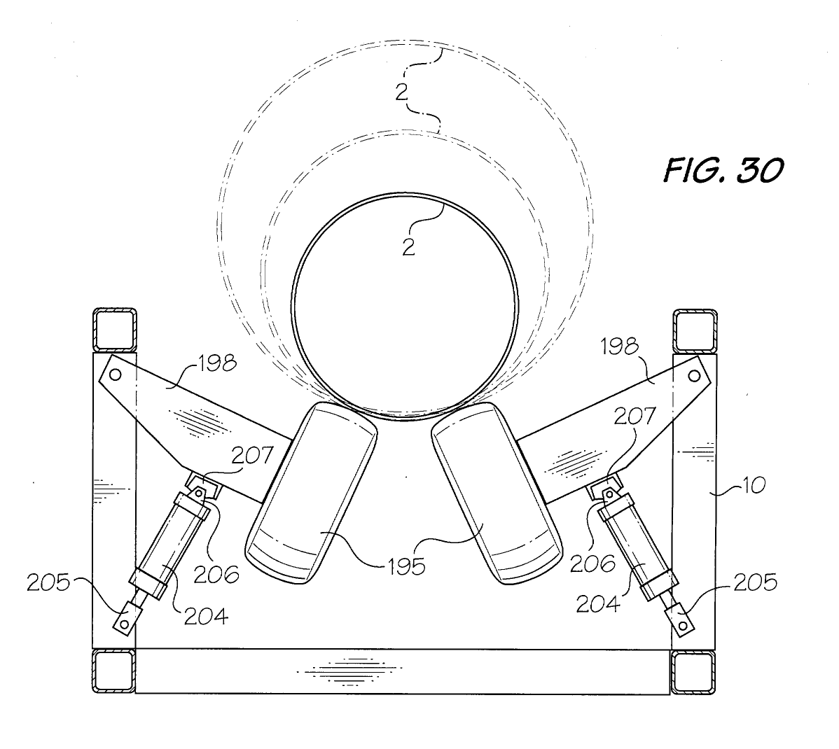

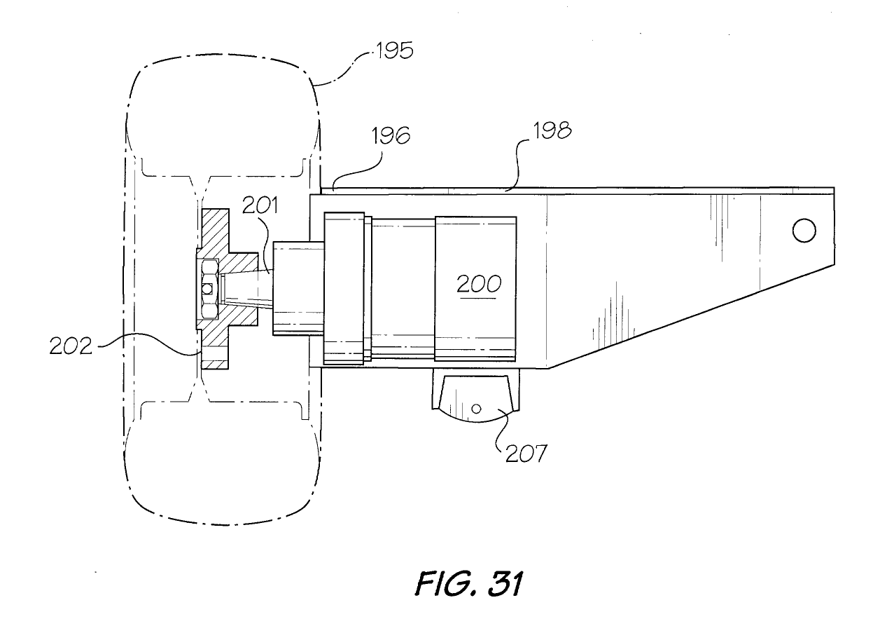

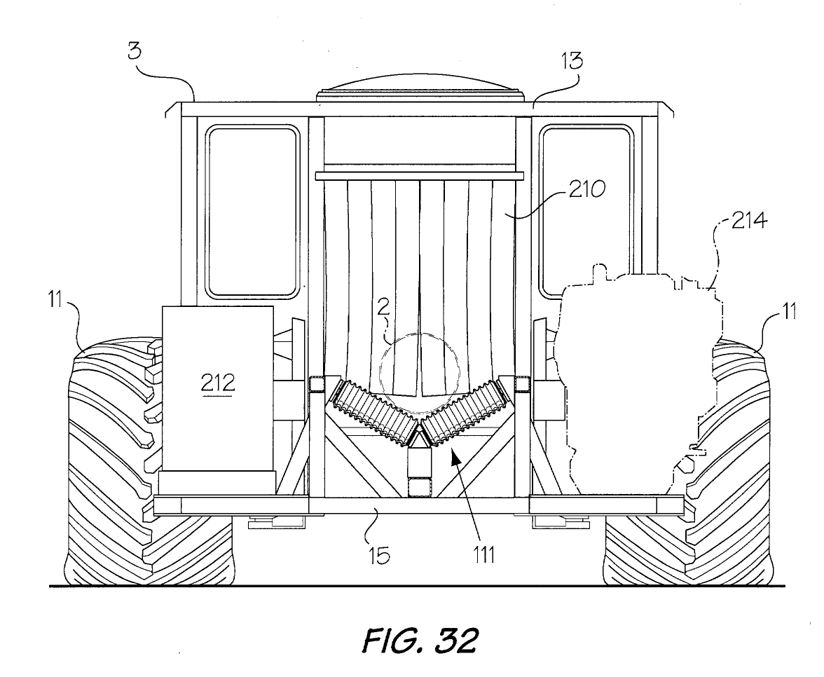

Once a pipe section 2 has been properly aligned with pipe sections previously fed into the apparatus, the new pipe section 2 must be fed longitudinally into abutment with the existing pipeline. Such feeding is effected using pull wheels 195 (FIG. 30) mounted on the free ends 196 (FIG. 31) of a pair of opposed arms 198, which are pivotally mounted on the sides of the frame 10. The wheels 195 are rotated by hydraulic motor 200 (one shown in FIG. 31) mounted on the arms 198, the shafts 201 of the motors 200 being connected to the pull wheel hubs 202. The wheels 195 are raised to contact the pipe sections 2 by hydraulic cylinders 204 pivotally connected to the frame 10 by devises 205, and piston rods 206 pivotally connected to brackets 207 on the arms 198.

Pipe sections 2 abutting existing interconnected pipe sections enter the cab 13 as the vehicle 3 advances. In the cab 13, a welding device (not shown) applies a root weld to butt join the front pipe sections 2 to the pipeline. The pipeline then passes through curtains 210 (FIG. 32) at the back of the cab 18. The rear frame section 15 also carries hydraulic tanks 211 (FIGS. 2, 3 and 5) a diesel generator 212 and a main diesel engine 214. A fresh pipe section 2 is placed in the frame 10 and the process described above is repeated.

I claim:

1. An apparatus for producing a pipeline comprising:
(a) first vehicle means for receiving, aligning effecting a first weld between and maintaining sections of pipe in position over a trench in the ground while traveling over the trench to form a length of pipeline above the trench:
(b) second vehicle means for slidably receiving the sections of pipe and effecting at least one additional weld to said sections while following said first vehicle means over the trench;
(c) third vehicle means for slidably receiving the length of pipeline and inspecting welds and inspecting weld joints between the sections while following said first and second vehicle means over the trench;
(d) fourth vehicle means for covering said welds to complete the length of pipeline while following the first, second and third vehicle means over the trench; and
(e) fifth vehicle means for slidably receiving the length of pipeline, installing the length of pipeline in the trench and back-filling the trench while following the first, second, third and fourth vehicle means over the trench.

2. The apparatus of claim 1, wherein said first vehicle means includes:
(i) skeletal frame means for straddling the trench;
(ii) cradle means for receiving and carrying a plurality of sections of pipe;
(iii) wheel means for carrying said frame means along the ground above the trench
(iv) conveyor means for receiving said sections of pipe one at a time from said cradle means;
(v) manipulating means on said frame means for aligning sections of pipe prior to forming a length of pipe; and
(vi) feed means on said frame means for maintaining sections of pipe stationary over the trench while the first vehicle moves along said path of travel; and
(vii) first welding means for effecting said first weld between sections of pipe while all said vehicle means are traveling over the ground.

3. The apparatus of claim 1, wherein said second vehicle means includes:
(i) a plurality of welding vehicles for applying layers of weld to aligned sections of pipe for interconnecting the pipe sections and forming a length of pipeline.

4. The apparatus of claim 1, wherein said fourth vehicle means includes an applicator for applying with a shrink wrapped plastic cover to said weld joints.

5. A vehicle for handling pipe sections in the production of a pipeline comprising:
(a) skeletal frame means for straddling a trench in the ground;
(b) wide, soft wheel means for carrying said frame means over the ground while straddling the trench;
(c) cradle means on said frame means for receiving pipe sections;
(d) conveyor means on said frame means for receiving pipe sections one at a time from said cradle means;
(e) manipulating means on said frame means for aligning sections of pipe prior to forming a length of pipe;
(f) feed means on said frame for causing successive pipe sections to abut and to remain in a fixed position above the trench while the vehicle travels over the trench; and
(g) welding means for effecting a weld between sections of pipe while the vehicle travels over the ground.

6. The apparatus of claim 5, including motor means connected to each said wheel means, whereby each said wheel means is independently driven.

7. The apparatus of claim 6, including brake means connected to each said wheel means for independent braking of each said wheel means.

8. The apparatus of claim 6, including steering means interconnecting each wheel means on one side of said frame means with a corresponding, laterally aligned wheel means on the other side of said frame means, whereby each pair of laterally aligned wheel means are steered in unison.

9. The apparatus of claim 8, including a plurality of vertical track means on each side of said frame means; carriage means rotatable and vertically movable on each said track means, said carriage means containing said motor means and carrying said wheel means, whereby each said wheel means can be steered and moved vertically with respect to said frame means for adjusting the clearance between the frame means the ground.

10. The apparatus of claim 5, wherein said cradle means includes inclined cradle arm means above said frame means for receiving a plurality of pipe sections; and stop means for retaining the pipe sections on said cradle arm means and releasing said pipe sections one at a time for feeding onto said conveyor means.

11. The apparatus of claim 10, including pivot arm means on said frame means above said conveyor means for receiving pipe sections from said cradle means and releasing the pipe sections to the conveyor means.

12. The apparatus of claim 11, including elevator means for retaining said pivot arm means in an elevated, pipe section receiving position, and for receiving the pipe sections from the pivot arm means and lowering the pipe sections onto said conveyor means.

13. The apparatus of claim 5, wherein said conveyor means includes a plurality of V-shaped roller assemblies for receiving pipe sections of a variety of diameters.

14. The apparatus of claim 13, wherein each roller assembly includes a pair of inclined, corrugated rollers rotatable in said frame means.

15. The apparatus of claim 13, wherein said manipulating means includes an adjustment mechanism for moving a pipe section vertically and laterally with respect to the frame.

16. The apparatus of claim 15, wherein said manipulating means includes a rotator for rotating individual pipe sections on said conveyor means.
